(19) United States
(12) Patent Application Publication
(10) Pub. No.: US 2014/0079999 A1
(43) Pub. Date: Mar. 20, 2014

(54) CATHODE MATERIAL

(71) Applicant: HONDA MOTOR CO., LTD., TOKYO (JP)

(72) Inventors: Shintaro Aoyagi, Wako-shi (JP); Yuji Isogai, Wako-shi (JP); Kaoru Omichi, Wako-shi (JP)

(73) Assignee: HONDA MOTOR CO., LTD., TOKYO (JP)

(21) Appl. No.: 14/030,214

(22) Filed: Sep. 18, 2013

(30) Foreign Application Priority Data
Sep. 20, 2012 (JP) 2012-206846
Aug. 2, 2013 (JP) 2013-161600

(51) Int. Cl. H01M 4/36

(52) U.S. Cl. CPC H01M 4/366
USPC 429/221

(57) ABSTRACT

The present invention provides a cathode material that can achieve a high energy density and excellent instantaneous output characteristics in lithium ion secondary batteries. The cathode material is used in a lithium ion secondary battery 1, and contains FeF₃ and carbon-coated LiFePO₄ as cathode active materials.

### BACKGROUND OF THE INVENTION

1. Field of the Invention

The present invention relates to a cathode material.

2. Description of the Related Art

It is desired that secondary batteries for electric vehicles have a high energy density to increase driving distance and also have excellent output characteristics when the current density instantaneously changes during high speed running or hill-climbing (hereinbelow, sometimes referred to as instantaneous output characteristics).

Heretofore, nickel-hydrogen secondary batteries comprising two active materials different in charge and discharge characteristics, that is, a high-output type cathode active material and a low-output type cathode active material have been known as secondary batteries having high energy density and excellent instantaneous output characteristics. The nickel-hydrogen secondary batteries have nickel hydroxide as a cathode active material, and comprise a high-output type cathode active material and a low-output type cathode active material that have different masses of the nickel hydroxide (for example, see International Publication No. WO 2003/026054).

However, the conventional art is an invention relating to nickel-hydrogen secondary batteries that use an alkaline electrolytic solution such as potassium hydroxide, providing no description or indication of lithium ion secondary batteries using a non-aqueous electrolyte solution.

### SUMMARY OF THE INVENTION

In view of the circumstances, it is thus the object of the present invention to provide a cathode material that is able to achieve a high energy density as well as excellent instantaneous output characteristics in lithium ion secondary batteries.

To achieve the object, combined use of a cathode active material having high energy density and a cathode active material having excellent instantaneous output characteristics in lithium ion secondary batteries is envisioned.

Among cathode active materials used in the lithium ion secondary batteries, FeF₃ is known to have a theoretical energy density of about 240 mAh/g (for example, see Japanese Patent Laid-Open No. 2008-130265). However, since FeF₃ takes time to react with lithium ions in the cathode, it cannot be said that FeF₃ is excellent in instantaneous output characteristics.

LiFePO₄ is also known as a cathode active material used in the lithium ion secondary batteries (for example, see Japanese Patent Laid-Open No. 2012-164441). LiFePO₄ is likely to diffuse lithium ions in cathodes of lithium ion secondary batteries and is excellent in instantaneous output characteristics. However, it cannot be said that LiFePO₄ has a sufficient energy density.

Thus, a combination of FeF₃ and LiFePO₄ is envisioned as cathode active materials in the lithium ion secondary batteries, but a problem is that only mixing both the materials is not sufficient to achieve a high energy density as well as excellent instantaneous output characteristics, since it cannot provide a greater effect than the sum of effects depending on the ratio of the cathode active materials.

To achieve the object, the present invention provides a cathode material used in lithium ion secondary batteries, wherein the cathode material comprises FeF₃ and carbon-coated LiFePO₄ as cathode active materials.

The cathode material of the present invention contains FeF₃ and LiFePO₄ as cathode active materials, both of which differ in reaction potentials in the cathode reaction. Accordingly, lithium ions can be exchanged between FeF₃ and LiFePO₄. At this time, LiFePO₄, which is coated with carbon, can reduce the interface resistance at the interface with FeF₃ to facilitate delivery and receipt of lithium ions.

FeF₃ thus can rapidly advance the cathode reaction by lithium ions supplied from LiFePO₄ and also can allow the part that cannot be used in the cathode reaction by FeF₃ alone to contribute to the cathode reaction to thereby achieve a high energy density. Additionally, since LiFePO₄ is coated with carbon, the electric conductivity of the LiFePO₄ itself is increased, and at the same time, the interface resistance with a non-aqueous electrolyte solution is decreased to facilitate transfer of electric charges.

As a result, by use of the cathode material of the present invention, in a view to achieve a high energy density as well as excellent instantaneous output characteristics in lithium ion secondary batteries, a greater effect than the sum of effects based on the ratio of FeF₃ and LiFePO₄ can be achieved.

In this context, the cathode material of the present invention preferably has a mass ratio of FeF₃ to carbon-coated LiFePO₄ of 86:14 to 57:43.

By the mass ratio of FeF₃ to carbon-coated LiFePO₄ defined within the range, the cathode material of the present invention can securely achieve a high energy density as well as excellent instantaneous output characteristics. When the mass ratio of FeF₃ to carbon-coated LiFePO₄ lies out of the range, either one or both of a high energy density and excellent instantaneous output characteristics may not be achieved.

Moreover, the cathode material of the present invention preferably contains a conductive auxiliary. The cathode material of the present invention can further facilitate transfer of electric charges by containing a conductive auxiliary.

When containing the conductive auxiliary, the cathode material of the present invention is preferably composed of FeF₃ in the range of 40 to 60% by mass, carbon-coated LiFePO₄ in the range of 10 to 30% by mass, and the conductive auxiliary in the range of 20 to 30% by mass such that a total thereof becomes 100% by mass.

By the fact that the composition of FeF₃, carbon-coated LiFePO₄, and the conductive auxiliary lies within the range, the cathode material of the present invention can transfer electric charges more easily and securely. When the composition of FeF₃, carbon-coated LiFePO₄, or the conductive auxiliary lies out of the range, transfer of electric charges may be insufficiently lower.

### BRIEF DESCRIPTION OF THE DRAWINGS

FIG. 1 is an illustrative cross section showing one exemplary configuration of a lithium ion secondary battery using a cathode material of the present invention;

FIG. 2 is a graph showing the relationship between the capacity and the voltage of lithium ion secondary batteries obtained in Example 1 and Comparative Examples 1 and 2;

FIG. 3 is a graph showing capacity retention ratio to the current density of the lithium ion secondary batteries obtained in Example 1 and Comparative Example 1;

FIG. 4A and FIG. 4B are graphs showing a voltage drop (IR drop) when a first discharge is performed for 30 minutes after a charge in the lithium ion secondary batteries obtained in Example 1 and Comparative Example 1, where FIG. 4A is a graph showing the relationship between the capacity and the voltage, and FIG. 4B is a graph showing the relationship between the capacity and the IR drop;

FIG. 5A and FIG. 5B are graphs showing a voltage drop (IR drop) when a first discharge is performed for 200 minutes after a charge in the lithium ion secondary batteries obtained in Example 1 and Comparative Example 1, where FIG. 5A is a graph showing the relationship between the capacity and the voltage, and FIG. 5B is a graph showing the relationship between the capacity and the IR drop; and

FIG. 6A and FIG. 6B are graphs showing a voltage drop (IR drop) when a first discharge is performed for 400 minutes after a charge in the lithium ion secondary battery obtained in Example 1, FIG. 6A is a graph showing the relationship between the capacity and the voltage, and FIG. 6B is a graph showing the relationship between the capacity and the IR drop.

### DETAILED DESCRIPTION OF THE PREFERRED EMBODIMENTS

Embodiments of the present invention will now be further described in detail by referring to the accompanying drawings.

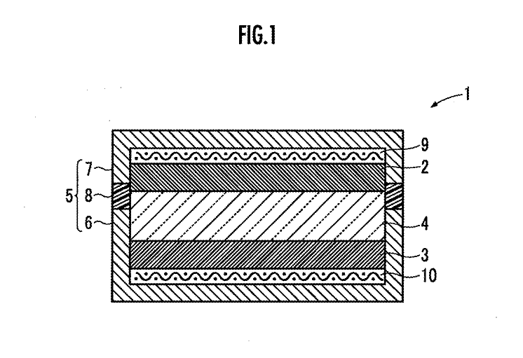

A cathode material according to this embodiment is used in, for example, a lithium ion secondary battery 1 shown in FIG. 1. The lithium ion secondary battery 1 comprises a positive electrode 2 in which FeF₃ and carbon-coated LiFePO₄ are used as cathode active materials, a negative electrode 3 in which metal lithium is used as an anode active material, and an electrolyte layer 4 placed between the positive electrode 2 and the negative electrode 3. The positive electrode 2, the negative electrode 3, and the electrolyte layer 4 are hermetically accommodated in a case 5. The case 5 comprises a cup-shaped case body 6 and a lid body 7 to close the case body 6, and an insulating resin 8 is interposed between the case body 6 and the lid body 7. Moreover, the positive electrode 2 comprises a positive electrode current collector 9 between the positive electrode 2 and the top surface of the lid body 7, and the negative electrode 3 comprises a negative electrode current collector 10 between the negative electrode 3 and the bottom of the case body 6. In this case, the case body 6 serves as a negative plate and the lid body 7 serves as a positive plate in the lithium ion secondary battery 1.

In the lithium ion secondary battery 1, the positive electrode 2 is composed of a cathode material and a binding agent, and the cathode material is composed of FeF₃ and carbon-coated LiFePO₄ as cathode active materials, and a conductive auxiliary.

Examples of the conductive auxiliary include carbon materials such as carbon black, acetylene black, carbon nanotubes, and Ketjen black. Additionally, examples of the binding agent include polytetrafluoroethylene (PTFE).

The cathode material is composed of FeF₃ in the range of 30 to 90% by mass, carbon-coated LiFePO₄ in the range of 1 to 40% by mass, and the conductive auxiliary in the range of 1 to 30% by mass provided that the total amount is 100% by mass.

The cathode material can be produced, for example, as follows. First, FeF₃ and the conductive auxiliary are mixed to prepare a first mixture. Although the mixing can be performed with a ball mill or a homogenizer, a ball mill is preferably used when FeF₃ or the conductive auxiliary is pulverized and mixed as well as ground to particulates.

Next, carbon-coated LiFePO₄ and the conductive auxiliary are mixed to prepare a second mixture. The mixing is preferably performed with a homogenizer to prevent the carbon coated on LiFePO₄ from being delaminated.

In this context, it is intended herein that, irrespective of the composition, the mixture of FeF₃ and the conductive auxiliary is referred to as a first mixture and the mixture of LiFePO₄ and the conductive auxiliary is referred to as a second mixture.

Then, the first mixture and the second mixture are mixed such that a desired mass ratio of FeF₃, carbon-coated LiFePO₄, and the conductive auxiliary is achieved to thereby obtain the cathode material. The cathode material can be further mixed with the binding agent to be formed into the positive electrode 2.

An example of the electrolyte layer 4 may include a non-aqueous electrolyte solution of lithium salt dissolved in a non-aqueous solvent with which a separator is impregnated. An example of the lithium salt may include lithium hexafluorophosphate (LiPF₆), and an example of the non-aqueous solvent may include a mixed solvent of ethylene carbonate and diethyl carbonate.

Examples of the current collectors 9 and 10 may include current collectors made of mesh of titanium, stainless steel, nickel, aluminum, and copper.

Examples of the present invention and Comparative Examples now will be described.

### EXAMPLE 1

In this Example, first, 1 g of FeF₃ (manufactured by Aldrich Corporation) and 0.428 g of Ketjen black (manufactured by Lion Corporation, trade name: Ketjen black EC600JD) were treated and mixed with a ball mill at 400 rpm for an hour to prepare a first mixture.

Next, 1 g of carbon-coated LiFePO₄ (manufactured by Hohsen Corp.) and 0.428 g of the same Ketjen black as used in the first mixture were treated and mixed with a thin film high-speed rotating mixer (manufactured by PRIMIX Corporation) at 30 m/s for three minutes to prepare a second mixture.

Then, 21.43 mg of the first mixture and 8.57 mg of the second mixture were mixed to prepare a cathode material. The cathode material obtained in this Example contains FeF₃, carbon-coated LiFePO₄, and Ketjen black in a mass ratio of 50:20:30. In this context, the mass ratio of FeF₃ to carbon-coated LiFePO₄ is 71:29.

Then, 30 mg of the cathode material and an emulsion containing 3.45 mg of polytetrafluoroethylene (PTFE) were mixed in an agate mortar to give a mixture, which was formed into pellets using a powder compacting machine. The pelletized cathode material was pressed onto a positive electrode current collector 9 of aluminum mesh to form a positive electrode 2.

Then, lithium foil was applied on a negative electrode current collector 10 composed of an SUS plate on which SUS mesh was welded to thereby form an negative electrode 3.

Then, the negative electrode 3 was arranged inside an SUS case body 6, which was of a cylindrical shape with a bottom, so as to bring the negative electrode current collector 10 into contact with the bottom of the case body 6. On the negative electrode 3, a separator made of a polypropylene microporous film was laminated. Then, the positive electrode 2 and the positive electrode current collector 9 obtained as mentioned above were laminated on the separator so as to bring the positive electrode 2 into contact with the separator. Into the separator, a non-aqueous electrolyte solution was poured to form an electrolyte layer 4.

As the non-aqueous electrolyte solution, a solution in which lithium hexafluorophosphate (LiPF₆) as a supporting salt was dissolved in a concentration of 1 mol/liter in a mixed solution of ethylene carbonate and diethyl carbonate having a mass ratio of 7:3 was used.

Then, the laminate, which was composed of the negative electrode current collector 10, the negative electrode 3, the electrolyte layer 4, the positive electrode 2, and the positive electrode current collector 9, accommodated in the case body 6 was covered with an SUS lid body 7. At this time, a ring-shaped insulating resin 8 was placed between the case body 6 and the lid body 7 to give a lithium ion secondary battery 1 shown in FIG. 1.

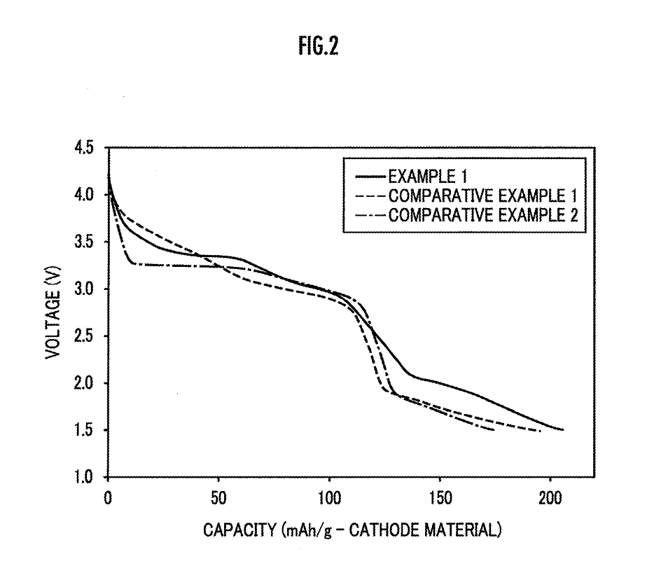

Then, by use of the lithium ion secondary battery 1 obtained in this Example, a discharge test was performed in an atmosphere at room temperature (25° C.) in a voltage range of 1.5 to 4.25 V with respect to Li/Li⁺ and at a current density of 0.1 mA/cm². The relationship between the capacity and the voltage at this time is shown in FIG. 2. Additionally, the energy density and the output density are shown in Table 1.

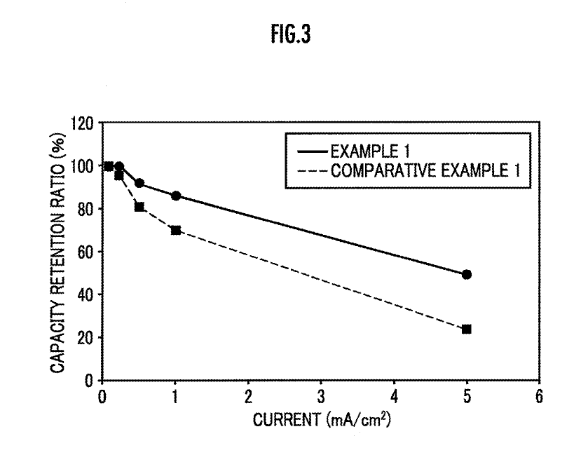

After that, by use of the lithium ion secondary battery 1 obtained in this Example, a capacity retention ratio to the current density was measured while charge and discharge were repeated in an atmosphere at room temperature (25° C.) in a voltage range of 1.5 to 4.25 V with respect to Li/Li⁺ and at a current density of 0.1 to 5.0 mA/cm². The result is shown in FIG. 3. The capacity retention ratio is an indicator showing how much of the initial capacity can be maintained in a high current range. It can be determined that a battery having a higher value in the high current range is better in the charge and discharge characteristics in the high current range and have better output characteristics.

Then, the lithium ion secondary battery 1 obtained in this Example was charged in an atmosphere at room temperature (25° C.) at a constant current density of 0.2 mA/cm² to a voltage of 4.25 V with respect to Li/Li⁺, discharged at a constant current density of 0.2 mA/cm² for 30 minutes, and then, discharged at a constant current density of 5.0 mA/cm² for one minute. A voltage drop (hereinbelow, referred to as an IR drop) when the current density was changed from 0.2 mA/cm² to 5.0 mA/cm² was measured. Subsequently, after discharged at a constant current density of 0.2 mA/cm² for 30 minutes, the battery was discharged at a constant current density of 5.0 mA/cm² for one minute, and the operation to measure an IR drop when the current density was changed from 0.2 mA/cm² to 5.0 mA/cm² was repeated three times.

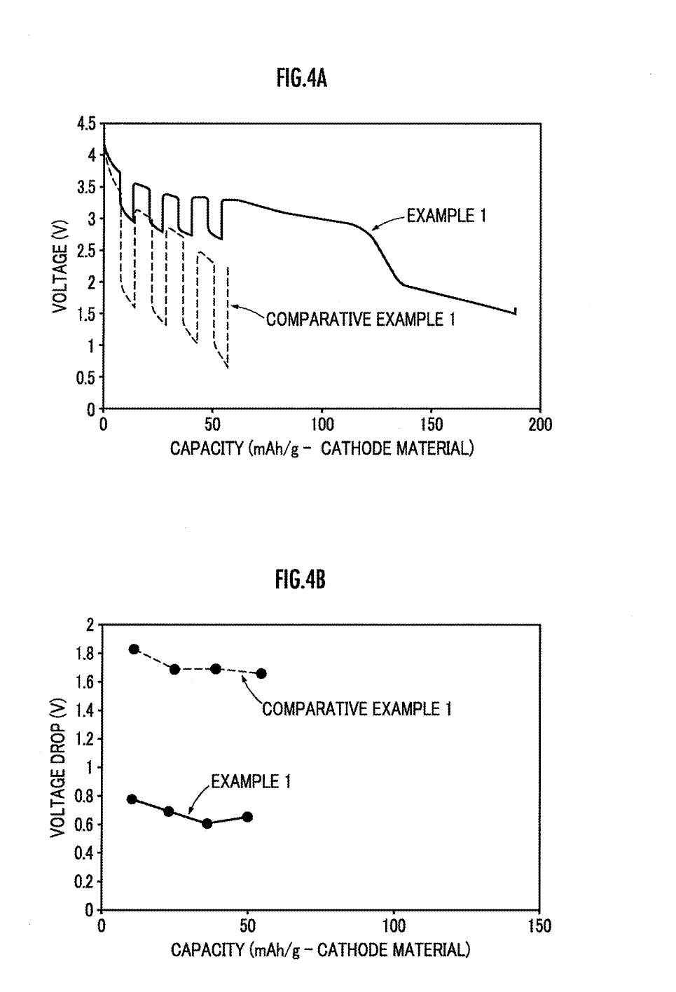

The relationship between the capacity and the voltage at this time is shown in FIG. 4A, and the relationship between the capacity and the IR drop is shown in FIG. 4B.

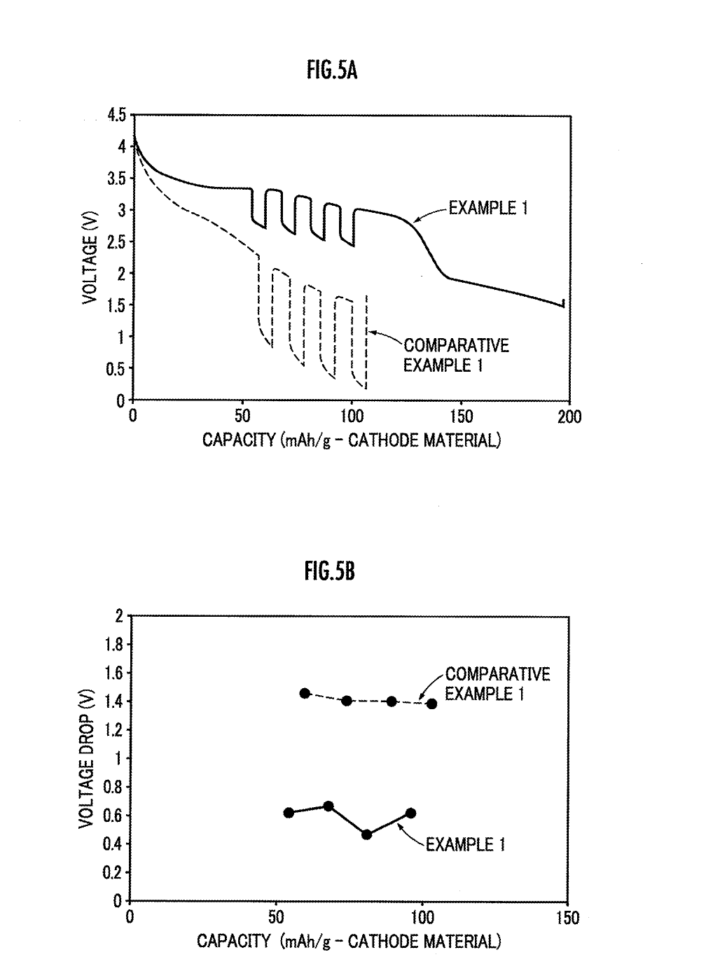

After that, the IR drop was measured just as the case of FIG. 3, except that the first discharge after the charge was performed for 200 minutes. The relationship between the capacity and the voltage at this time is shown in FIG. 5A, and the relationship between the capacity and the IR drop is shown in FIG. 5B.

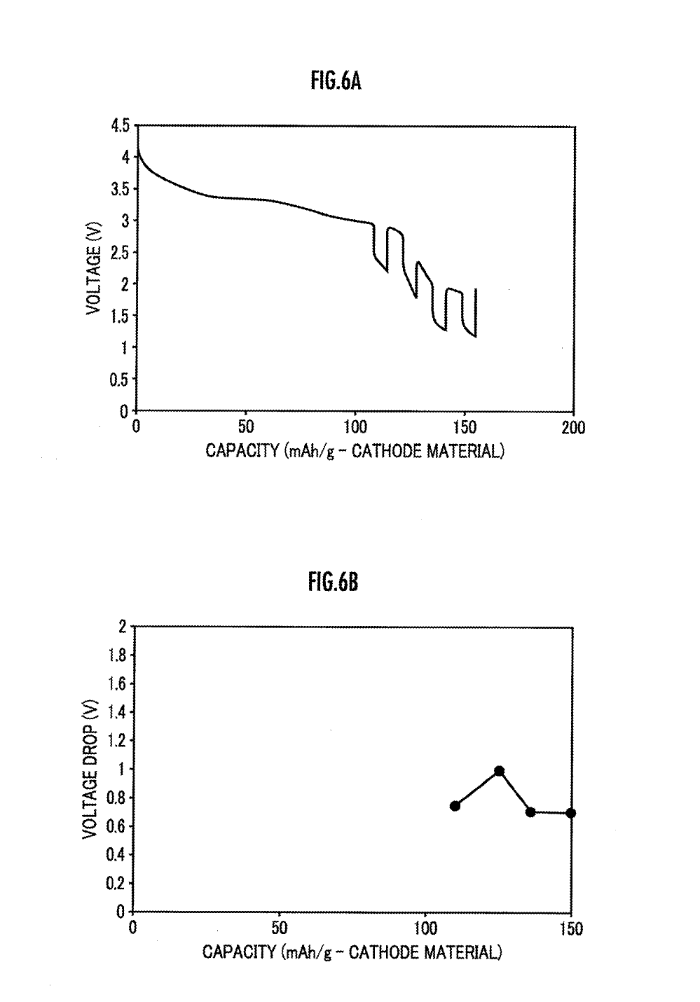

Further, the IR drop was measured just as the case of FIG. 3, except that the first discharge after the charge was performed for 400 minutes. The relationship between the capacity and the voltage at this time is shown in FIG. 6A, and the relationship between the capacity and the IR drop is shown in FIG. 6B.

### EXAMPLE 2

In this Example, 25.71 mg of the first mixture and 4.29 mg of the second mixture were mixed to prepare a cathode material. The cathode material obtained in this Example contains FeF₃, carbon-coated LiFePO₄, and Ketjen black in a mass ratio of 60:10:30. In this context, the mass ratio of FeF₃ to carbon-coated LiFePO₄ is 86:14.

Then, the lithium ion secondary battery 1 shown in FIG. 1 was obtained just as in Example 1, except that the above-mentioned cathode material was used.

After that, a discharge test was performed just as in Example 1, except that the lithium ion secondary battery 1 obtained in this Example was used. The energy density and the output density at this time are shown in Table 1.

### EXAMPLE 3

In this Example, 17.14 mg of the first mixture and 12.86 mg of the second mixture were mixed to prepare a cathode material. The cathode material obtained in this Example contains FeF₃, carbon-coated LiFePO₄, and Ketjen black in a mass ratio of 40:30:30. In this context, the mass ratio of FeF₃ to carbon-coated LiFePO₄ is 57:43.

Then, the lithium ion secondary battery 1 shown in FIG. 1 was obtained just as in Example 1, except that the above-mentioned cathode material was used.

After that, a discharge test was performed just as in Example 1, except that the lithium ion secondary battery 1 obtained in this Example was used. The energy density and the output density at this time are shown in Table 1.

### EXAMPLE 4

In this Example, the first mixture was prepared just as in Example 1, except that the amount of Ketjen black was 0.25 g. Additionally, the second mixture was prepared just as in Example 1, except that the amount of Ketjen black was 0.25 g.

Next, 18.75 mg of the first mixture and 11.25 mg of the second mixture were mixed to prepare a cathode material. The cathode material obtained in this Example contains FeF₃, carbon-coated LiFePO₄, and Ketjen black in a mass ratio of 50:30:20. In this context, the mass ratio of FeF₃ to carbon-coated LiFePO₄ is 62:38.

Then, the lithium ion secondary battery 1 shown in FIG. 1 was obtained just as in Example 1, except that the above-mentioned cathode material was used.

After that, a discharge test was performed just as in Example 1, except that the lithium ion secondary battery 1 obtained in this Example was used. The energy density and the output density at this time are shown in Table 1.

### COMPARATIVE EXAMPLE 1

In this Comparative Example, the lithium ion secondary battery 1 shown in FIG. 1 was obtained just as in Example 1, except that 30 mg of a cathode material composed of the first mixture alone was used. The cathode material of this Comparative Example contains FeF₃ and Ketjen black in a mass ratio of 70:30.

Then, a discharge test was performed just as in Example 1, except that the lithium ion secondary battery 1 obtained in this Comparative Example was used. The relationship between the capacity and the voltage at this time is shown in FIG. 2. Additionally, the energy density and the output density are shown in Table 1.

Then, capacity retention ratio was measured just as in Example 1, except that the lithium ion secondary battery 1 obtained in this Comparative Example was used. The result is shown in FIG. 3.

After that, IR drops were measured when a first discharge after the charge was performed for 30 minutes or 200 minutes just as in Example 1, except that the lithium ion secondary battery 1 obtained in this Comparative Example was used. The relationship between the capacity and the voltage when the first discharge after the charge was performed for 30 minutes is shown in FIG. 4A, and the relationship between the capacity and the IR drop is shown in FIG. 4B. Additionally, the relationship between the capacity and the voltage when the first discharge after the charge was performed for 200 minutes is shown in FIG. 5A, and the relationship between the capacity and the IR drop is shown in FIG. 5B.

### COMPARATIVE EXAMPLE 2

In this Comparative Example, 1 g of LiCoO₂ (manufactured by Nippon Chemical Industrial Co., Ltd.) and 0.428 g of the same Ketjen black as used in the first mixture were treated and mixed with a ball mill at 360 rpm for one hour to obtain a mixture of LiCoO₂ and the conductive auxiliary. The mixture corresponds to the second mixture in Example 1.

Then, 15 mg of the first mixture, 6 mg of the mixture of the LiCoO₂ and the conductive auxiliary, and 9 mg of the same Ketjen black as used in the first mixture were mixed to prepare a cathode material. The cathode material obtained in this Comparative Example contains FeF₃, LiCoO₂, and Ketjen black in a mass ratio of 50:20:30. Additionally, LiCoO₂, like LiFePO₄, serves as a cathode active material having excellent instantaneous output characteristics.

After that, a discharge test was performed just as in Example 1, except that the lithium ion secondary battery 1 obtained in this Comparative Example was used. The relationship between the capacity and the voltage at this time is shown in FIG. 2.

TABLE 1

| | Energy density | Output density |
|---|---|---|
| | (Wh/kg) | (Wh/kg) |
| Example 1 | 557 | 1326 |
| Example 2 | 560 | 1076 |
| Example 3 | 520 | 1738 |
| Example 4 | 605 | 1340 |
| Comparative Example 1 | 510 | 429 |

According to FIG. 2 and Table 1, it is clear that the cathode materials of Examples 1 to 4 have a higher output density in addition to a higher energy density and can provide better instantaneous output characteristics than the cathode material of Comparative Example 1.

In this context, since the cathode material of Comparative Example 1 is composed of FeF₃ alone, the energy density of the material is expected to be higher than the energy density of the cathode materials of Examples 1 to 4, which are composed of the mixture of FeF₃ and carbon-coated LiFePO₄. However, in fact, the cathode materials of Examples 1 to 4 have a higher energy density than the cathode material of Comparative Example 1. Thus, it is clear that use of the cathode materials of Examples 1 to 4 in lithium ion secondary batteries provides a greater effect than the sum of effects depending on the ratio of the cathode active materials, FeF₃ and LiFePO₄, from the viewpoint of achieving a high energy density and a high output density.

Additionally, according to FIG. 2, it is clear that the cathode material of Example 1 has a larger discharge capacity and a higher energy density than the cathode material of Comparative Example 2. In this context, the cathode material of Comparative Example 2 is the mixture of FeF₃ and LiCoO₂. LiCoO₂ is a cathode active material having as excellent instantaneous output characteristics as LiFePO₄ has. Thus, it is clear that the effect by the cathode material of Example 1 is an effect specific to the combination of FeF₃ and carbon-coated LiFePO₄ among cathode active materials having excellent instantaneous output characteristics.

Then, according to FIG. 3, it is clear that the cathode material of Example 1 has a higher capacity retention ratio across the entire range with a current density of 0.1 to 5.0 mA/cm² and has better output characteristics than the cathode material of Comparative Example 1.

Then, according to FIG. 4A and FIG. 5A, it is clear that, since the cathode material of Example 1 has a much smaller IR drop than the cathode material of Comparative Example 1, the cathode material of Example 1 has a small loss in the energy density when the current density instantaneously changes, and has excellent instantaneous output characteristics. As shown in FIG. 4B and FIG. 5B, the IR drop of the cathode material of Example 1 is from 0.5 to 0.8 V, whereas the IR drop of the cathode material of Comparative Example 1 is from 1.4 to 1.8 V. The IR drop of the cathode material of Example 1 is less than 50% of the IR drop of the cathode material of Comparative Example 1.

In this context, given that the mass ratio of FeF₃ to carbon-coated LiFePO₄ in the cathode material of Example 1 is 50:20, it is clear that use of the cathode material of Example 1 in lithium ion secondary batteries provides a greater effect than the sum of effects depending on the ratio of the cathode active materials, FeF₃ and LiFePO₄, from the viewpoint of achieving excellent instantaneous output characteristics.

Additionally, according to FIGS. 4 to 6, it is clear that the cathode material of Example 1, irrespective of the theoretical capacity of LiFePO₄ contained, has a substantially constant IR drop in a range of 0.5 to 1.0 V across the entire reaction range and has a small loss in the energy density when the current density instantaneously changes.

What is claimed is:

1. A cathode material used in a lithium ion secondary battery, the cathode material comprising FeF₃ and carbon-coated LiFePO₄ as cathode active materials.

2. The cathode material according to claim 1, wherein the mass ratio of FeF₃ to carbon-coated LiFePO₄ is in a range of 86:14 to 57:43.

3. The cathode material according to claim 1, further comprising a conductive auxiliary.

4. The cathode material according to claim 3, wherein the cathode material comprises:
FeF₃ in a range of 40 to 60% by mass;
carbon-coated LiFePO₄ in a range of 10 to 30% by mass; and
the conductive auxiliary in a range of 20 to 30% by mass, and
wherein a total thereof is 100% by mass.
